(19) United States
(12) Patent Application Publication
(10) Pub. No.: US 2009/0040685 A1
(43) Pub. Date: Feb. 12, 2009

(54) Power capacitor

(76) Inventors: Gerhard Hiemer, Nuernberg (DE); Edmund Schirmer, Postbauer/Heng (DE); Hermann Kilian, Diespeck (DE); Hermann Baeumel, Neumarkt (DE); Dietrich George, Bayreuth (DE); Wilhelm Grimm, Roth (DE); Wilhelm Huebscher, Heldenfingen (DE); Harald Vetter, Heidenheim (DE)

Correspondence Address: FASSE PATENT ATTORNEYS, P.A., P.O. BOX 726, HAMPDEN, ME, 04444-0726, US

(21) Appl. No.: 11/918,931

(22) PCT Filed: Mar. 9, 2006
(86) PCT No.: PCT/DE2006/000407

§ 371 Date: Nov. 20, 2007

(30) Foreign Application Priority Data
Apr. 19, 2005 (DE) 10 2005 018 172.4

(51) Int. Cl. H01G 4/38

(52) U.S. Cl. 361/301.5

(57) ABSTRACT

The present invention relates to a power capacitor (1) for the installation in a motor vehicle, comprising a capacitor unit (2) with at least one first and at least one second capacitor element (3, 4) whereby each capacitor element comprises at least two rolled-up plastic films that are provided with metal layers and are provided with metal-free edge strips on mutually opposite lying longitudinal sides, a circuit connection unit (5) and a housing (12), whereby the capacitor elements (3, 4) are circuit-connected in parallel by means of the circuit connection unit (5).

The invention relates to a power capacitor for installation in a motor vehicle with a capacitor unit that comprises at least one first and at least one second capacitor element, whereby each capacitor element encompasses at least two rolled-up plastic films that are provided with metal layers, and that are provided with metal-free edge strips on mutually opposite-lying longitudinal sides.

Such power capacitors are, for example, utilized as components of an electronic control in vehicles, such as for example hybrid vehicles or electric vehicles. Hybrid vehicles are vehicles that have two separate drive systems. Generally these are an electric motor and a combustion motor, which are coordinated through an electronic control. The electronic control consists of, among other things, a converter that is installed in the drive train of the hybrid vehicle and that converts DC voltage into AC voltage and provides energy in suitable form to the electric motor. The power capacitors serve for the intermediate energy storage in the DC current intermediate circuit. In order to fulfill this object or purpose even for rapidly variable energy quantities, they must comprise the smallest possible inductance. The power capacitor is utilizable for low voltages in the range of 36 volts (V) up to higher voltages of several hundred to thousand volts (V). The power capacitor can, for example, be operated at an operating voltage of 36 volts (V). It can, however, comprise a considerably higher operating voltage, such as 450 volts (V) for example. The motor currents typically lie in a range from 200 to 500 amperes (A).

It is the object of the present invention to provide a power capacitor that comprises sufficient capacitance in the smallest possible structural space.

According to the invention, this object is achieved by a power capacitor according to the features of the claim 1.

The power capacitor consists of a capacitor unit, which is constructed of several capacitor elements, preferably from a first and a second capacitor element, and is equipped or outfitted with a capacitance of 1000 μF each respectively, for example. The capacitor elements are circuit-connected in parallel by means of a circuit connection unit. Through the parallel circuit connection of the capacitor elements, a reduced capacitor series resistance arises in comparison to a series circuit connection. Upon the current loading of the power capacitor, this avoids electrical losses due to the smaller ohmic capacitor resistance.

A preferred embodiment of the invention consists in that each capacitor element comprises at least two rolled-up plastic films that are provided with metal layers and that are provided with metal-free edge strips on mutually opposite-lying longitudinal sides. The electrodes are respectively lead out on a roll end face, and there they are provided with contact layers that are produced according to the Schoop flame spraying method. On the one hand, this large surfacial metal Schooping of the roll end faces ensures a secure contacting connection between the electrodes and the connection elements. On the other hand, the parallel circuit connection of the plastic films contributes to the reduction of the inductance. Through the wrapped or rolled arrangement of the layer sequence, a high capacitance can be realized in the smallest possible space. The layer rolling or wrapping or winding technique furthermore enables a space-saving and simple construction of the capacitor elements.

The circuit connection unit for the circuit connection of the capacitor elements and for the electrical contacting of the power capacitor onto the power electronics unit of a motor vehicle comprises a first and a second circuit connection element, whereby the circuit connection elements comprise different potentials. Each circuit connection element comprises at least one outer connection element, whereby the outer connection elements adjoin or lie against one another with a small spacing distance and with different potentials, especially lying over one another, and are electrically insulated relative to one another. Thereby the low-inductance connection of the power capacitor to the power electronics unit is achieved. Moreover, this arrangement of the outer connection elements enables a structurally simple current feed or supply to the capacitor unit and a simple connection of low inductance busbars.

The structural embodiment and arrangement of the outer connection elements and of the current lines or conductors internally in the capacitor provide a decisive or primary contribution to the avoidance of the undesired self-inductance of the power capacitor.

Preferably, each circuit connection element comprises three outer connection elements, so that a total of six outer connection elements arise with two circuit connection elements, whereby respectively two connection elements with different potentials give rise to one outer connection unit. Thereby there arises a nearly symmetrical current distribution or division between the three connection units, so that the total capacitance is composed or made up of nearly equal partial capacitances.

A further advantageous embodiment of the power capacitor arises in that the circuit connection unit encompasses three individual circuit connection units that are mechanically and electrically separated from one another. Thereby there arises a symmetrical current distribution or division between the three circuit connection units, so that the total capacitance is composed or made up of equal partial capacitances. That has the advantage that the power capacitor can be operated respectively according to the desired capacitance.

In order to achieve a minimum self-inductance of the power capacitor, the inner circuit connection of the capacitor elements was carried out by means of busbars. The busbar construction encompasses two metallic conductors arranged on an electrically insulating carrier, whereby the metallic conductors represent the actual busbars. Preferably each circuit connection element comprises one busbar, via which the outer connection element is electrically and mechanically contactable with the capacitor unit. The busbars are arranged over one another and electrically insulated. The geometric dimensions, that is to say the width and length, of the busbars correspond in that regard to the geometric dimensions of the capacitor elements.

The inner circuit connection of the capacitor elements by means of the busbars is advantageously carried out in such a manner so that likewise a minimum and uniform self-inductance of all three outer connection units remains or arises. The self-inductance of a connection unit is reduced by approximately 30% by the inner circuit connection by means of busbars. The comparison of a measurement of an area or range of one connection unit and a parallel circuit connection of all three connection units shows that in one of the selected example embodiments each outer connection element comprises a self-inductance of approximately 9 nanohenry (nH). Thus, the self-inductance of the individual outer connection elements lies in the order of magnitude of the self-inductance of one capacitor element. The self-inductances of the outer connection units can, however, also comprise other values, for example if the connection configuration is changed, for example by changing the spacing distances between the connection units.

Advantageously each busbar comprises at least one second connection element for the electrical and mechanical connection of the busbar onto the capacitor unit. In an advantageous embodiment, the second connection elements are deformable connection elements with thermal tolerance and length compensation that are stamped out of the busbars. The second connection elements are connected with each capacitor element, for example by means of a solder or weld connection, whereby the electrical connection is larger than the expansion coefficient of the capacitor unit.

The capacitor unit is arranged in a housing, that is preferably produced of aluminum. The housing comprises mechanical housing connections that serve for the mechanical connection of the power capacitor onto the power electronics unit of a vehicle.

For the electrical insulation of the capacitor unit relative to the metallic housing, the capacitor unit is arranged in a first plastic shell, of which the geometric dimensions essentially correspond to the dimensions of the capacitor unit. The plastic shell is constructed or embodied so that it completely surrounds or encloses the capacitor unit except for one side. The creep distance or leakage path and the air gap or arcing distance of the capacitor unit is preferably achieved by at least one protruding upper edge of one half shell. Preferably the power capacitor comprises a second plastic shell. The first and second plastic shells, assembled or set together, give rise to or form a complete enclosure of the capacitor unit. The second plastic shell is constructed or embodied so it surrounds or encloses the circuit connection unit as well as the outer connection elements at least on one side, and thus protects the circuit connection unit as well as the outer connection elements against external influences.

If the circuit connection unit of the power capacitor encompasses three individual circuit connection units, which are mechanically and electrically separated from one another, then the second plastic shell is advantageously embodied or constructed in such a manner so that it consists of three second plastic shells and therewith encloses the three circuit connection units individually at least on one side as well as the outer connection elements at least partially.

The plastic shells are secure against electric discharge or arc puncture, i.e. are electric discharge puncture proof, and are produced of polycarbonate for example. In a further advantageous embodiment, the first plastic shell is foldable, whereby a space-saving and secure transport of the plastic shell is ensured.

The high volume expansion behavior of the capacitor unit upon heating requires, on the one hand, deformable second connection elements, and on the other hand, at least one mechanical energy storage element between the plastic shell and the capacitor unit. The mechanical energy storage element is preferably embodied as a spring pad. A spring pad is produced, for example, of silicone foam. Advantageously, the capacitor unit is flexibly held in a vibration-secured manner via spring pads that are applied on all sides on the inner side of the plastic shell. Alternatively, the spring pads can also be applied on the outer side of the plastic shell, so that the spring pads are located between housing and plastic shell. Preferably, a mechanically deformable plastic insert between the capacitor unit and the first plastic shell serves for the mechanical decoupling between capacitor unit and housing. The plastic insert extends advantageously over the entire surface area of the capacitor unit.

The power capacitor is arrangeable on a power electronics unit of a motor vehicle, whereby the power capacitor improves the electromagnetic compatibility of the power electronics unit.

In an advantageous embodiment, the power capacitor is constructed or embodied so that length and width of the power capacitor essentially comprise a ratio of two to one. Thus, for example, the width of the power capacitor amounts to approximately 130 millimeters (mm) with a length of 270 millimeters (mm).

In the following description, the features and details of the invention are explained more closely in connection with the accompanying drawings with respect to example embodiments. In that regard, features and relationships described in individual variants are basically also transferable to all example embodiments. In the drawings:

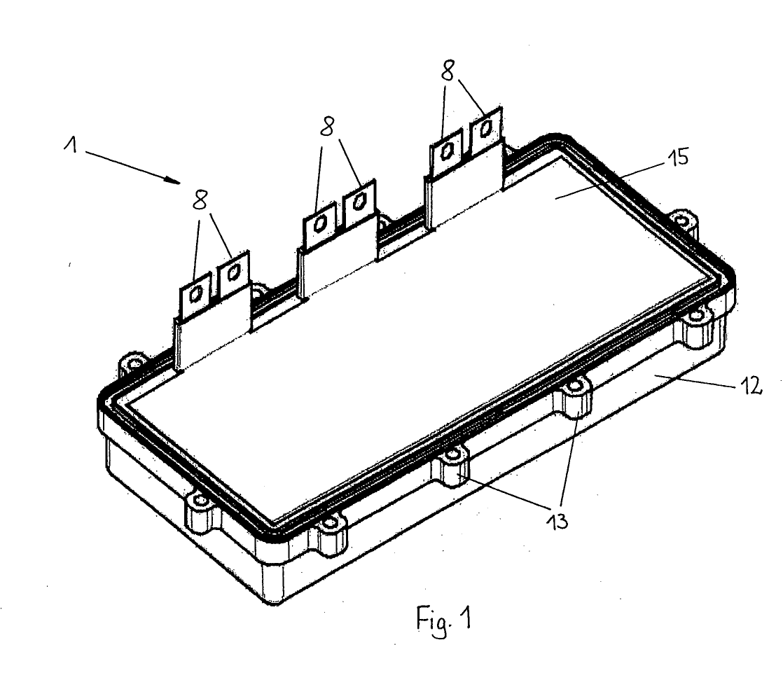

FIG. 1 shows an inventive power capacitor in a perspective view;

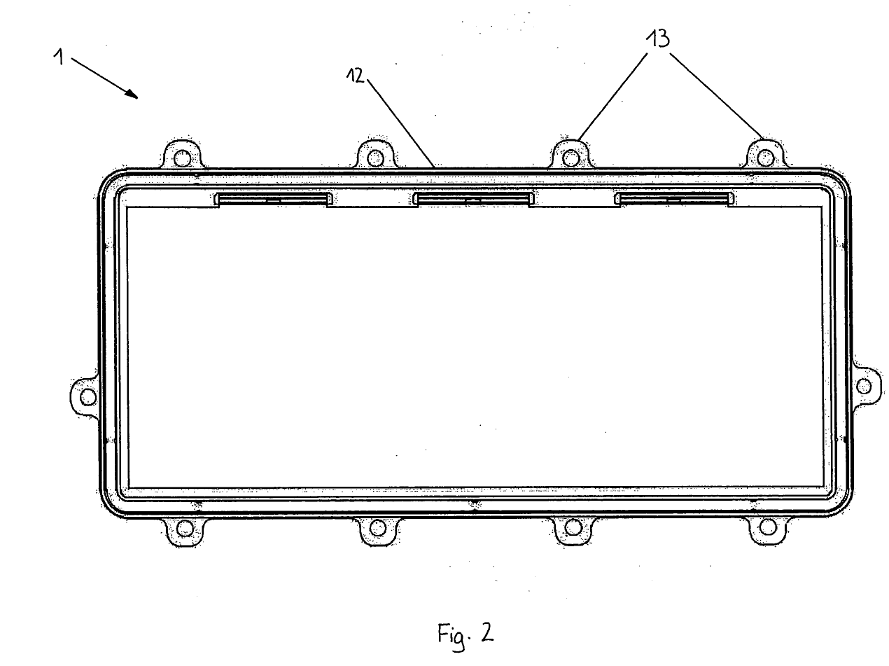

FIG. 2 shows a top plan view onto the inventive power capacitor;

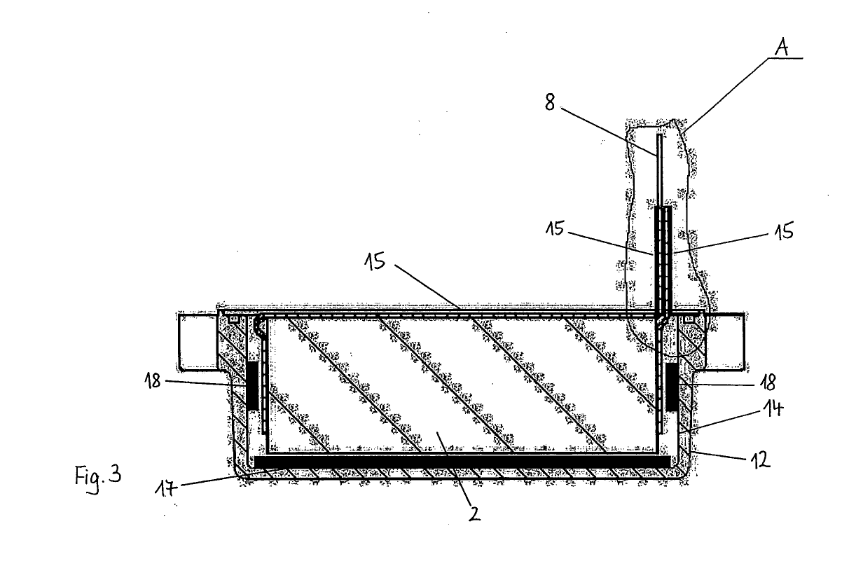

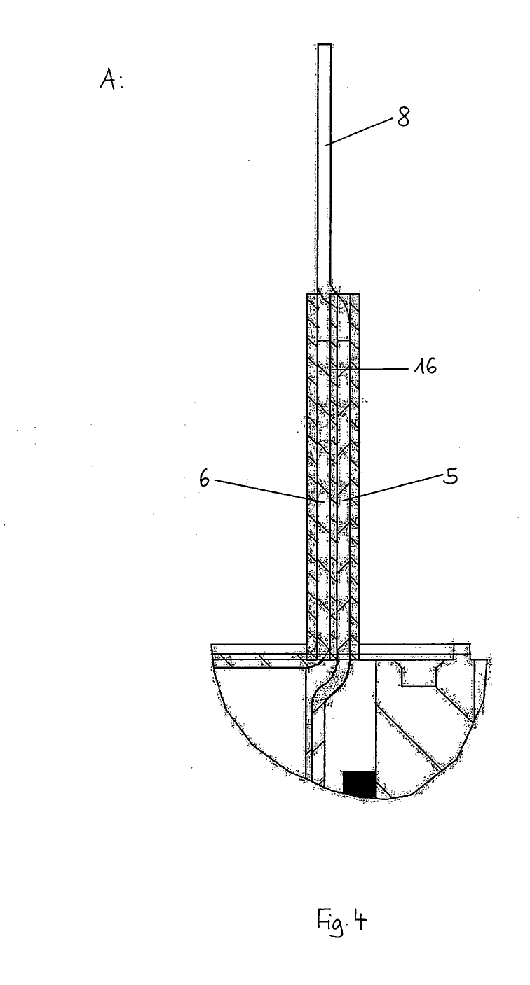

FIG. 3 shows a view of a cross-section through the inventive power capacitor;

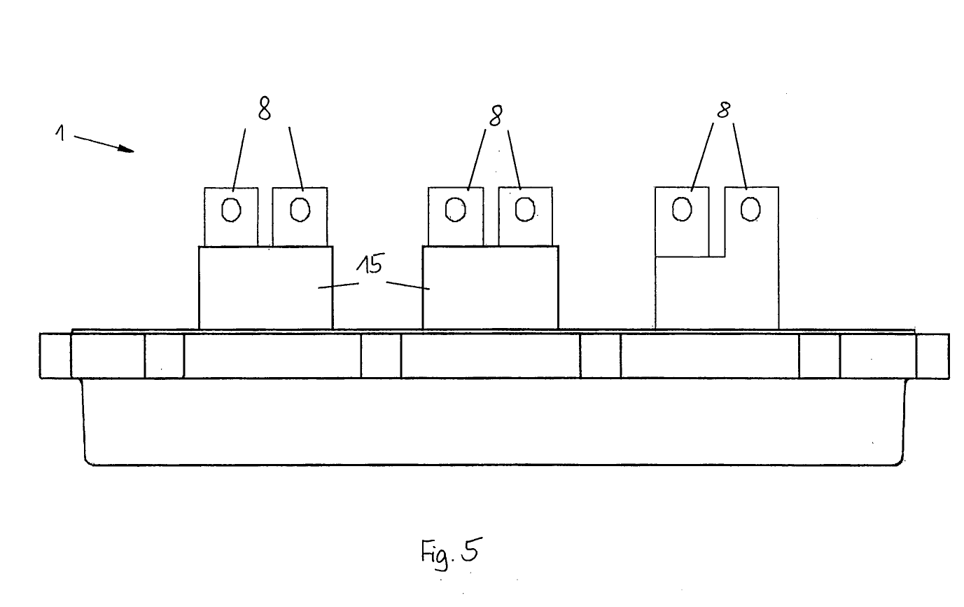

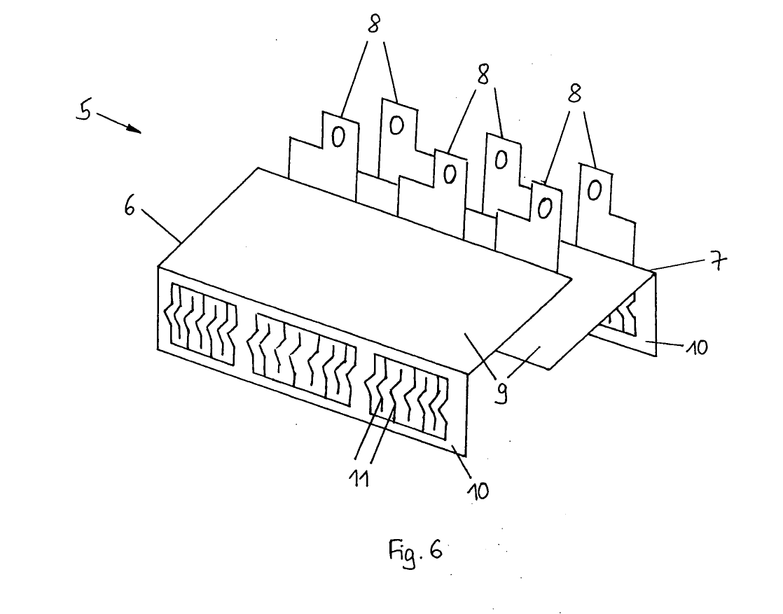

FIG. 4 shows a partial view of a cross-section through the inventive power capacitor;

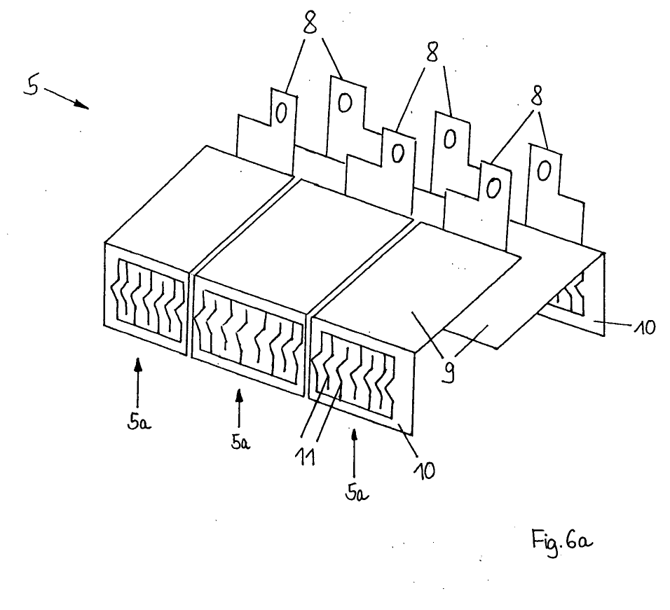

FIG. 5 shows a side view of the inventive power capacitor;

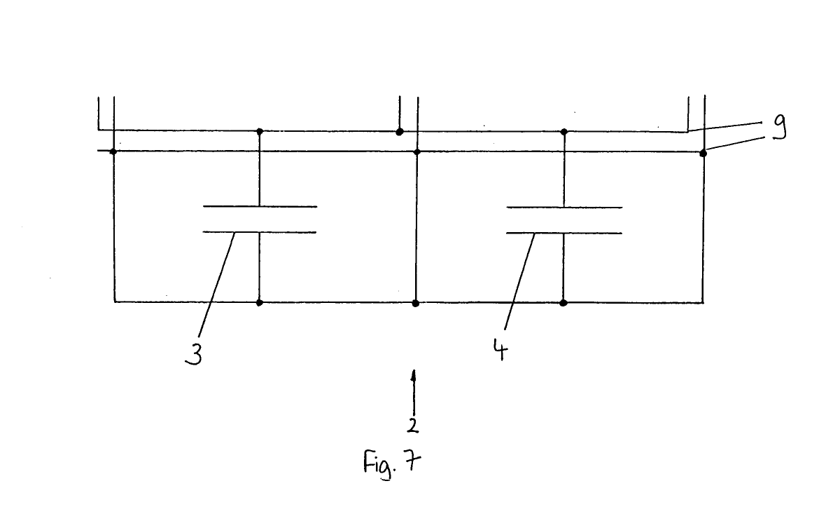

FIG. 6 shows a circuit connection unit of the inventive power capacitor;

FIG. 6a shows a further embodiment of the circuit connection unit;

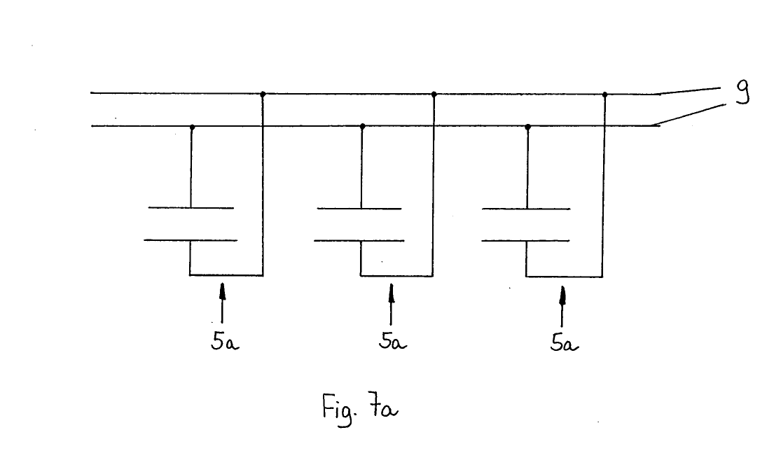

FIG. 7 shows a circuit diagram of the inventive power capacitor;

FIG. 7a shows a circuit diagram of the further embodiment of the circuit connection unit according to FIG. 6a.

In the Figures, the same reference characters are used for the same elements for better understandability of the description.

The inventive power capacitor 1 is shown in a perspective view in FIG. 1. The circuit connection unit, which is not shown, serves for the circuit connection of the capacitor elements, which are not shown, and by means of the outer connection elements 8 serves for the electrical contacting of the power capacitor 1 onto a power electronics unit which is not shown. The housing 12 is preferably produced of aluminum and comprises the mechanical housing connections 13, which serve for the mechanical connection of the power capacitor 1 onto a power electronics unit which is not shown. The second plastic shell 15 surrounds or encloses the circuit connection unit (not shown) at least on one side as well as the outer connection elements 8.

In FIG. 2, the inventive power capacitor 1 is shown in a top plan view. One especially recognizes the mechanical housing connections 13 of the housing 12.

A view of a cross-section through the inventive power capacitor 1 is shown in FIG. 3. The capacitor unit 2 is arranged in a first plastic shell 14, of which the geometric dimensions essentially correspond to the dimensions of the capacitor unit 2, for the electrical insulation or isolation of the capacitor unit 2 relative to the metallic housing 12. The plastic shell 14 is embodied or constructed so that it completely surrounds or encloses the capacitor unit 2 except for one side. At least one mechanical energy storage element 18, which is preferably embodied as a spring pad, is arranged between the plastic shell 14 and the capacitor unit 2. Advantageously, the capacitor unit 2 is held in a flexible and vibration-secure manner by several applied spring pads 18, which are applied on the inner side of the plastic shell 14. A mechanically deformable plastic insert 17 between the capacitor unit 2 and the first plastic shell 14 preferably serves for mechanical decoupling between capacitor unit 2 and housing 12. The plastic insert 17 extends advantageously over the entire surface area of the capacitor unit 2. Preferably the power capacitor 1 comprises a second plastic shell 15. The plastic shells 14 and 15, assembled or set together, form a complete enclosure of the capacitor unit 2. The plastic shell 15 is constructed or embodied so that it encloses or surrounds the circuit connection unit 5 on at least one side as well as the outer connection elements 8, and thus protects them against external influences.

A partial view of a cross-section through the inventive power capacitor 1 is illustrated in FIG. 4. Each circuit connection element 5 and 6 comprises at least one outer connection element 8, whereby the outer connection elements 8 lie against or adjoin one another with a small spacing distance and different potentials, and are electrically insulated or isolated relative to one another by means of the insulation 16.

A side view of the inventive power capacitor 1 is illustrated in FIG. 5. Especially it is to be recognized, that the second plastic shell 15 at least partially 8 surrounds or encloses the outer connection elements. Two outer connection elements 8 are illustrated without being surrounded or enclosed by means of the plastic shell 15.

A circuit connection unit of the inventive power capacitor 1 is shown in FIG. 6. The circuit connection unit 5 comprises a first circuit connection element 6 and a second circuit connection element 7, whereby the circuit connection elements 6 and 7 comprise different potentials. Each circuit connection element 6 and 7 comprises at least one outer connection element 8, whereby the outer connection elements 8 lie against or adjoin one another with small spacing distance and different potentials, and are electrically insulated or isolated relative to one another. Preferably each circuit connection element 6 and 7 comprises three outer connection elements 8, so that a total of six outer connection elements 8 arise for two circuit connection elements 6 and 7, whereby respectively two connection elements 8 with different potentials form or give rise to an outer connection unit. The busbars 9 are arranged over one another and are electrically insulated or isolated relative to one another. Advantageously each busbar 9 comprises at least one second connection element 10 for the electrical and mechanical connection of the busbar 9 to the capacitor unit not shown in FIG. 6. In an advantageous embodiment, the second connection elements 10 are deformable connection elements with thermal tolerance and length compensation, which are stamped out of the busbars 9. The second connection elements 10 are connected with the capacitor unit 2, which is not shown, for example by means of a solder or weld connection.

A further embodiment of the circuit connection unit 5 is illustrated in FIG. 6a. The circuit connection unit 5 encompasses three individual circuit connection units 5a, which are mechanically and electrically separated from one another. From that there arises a symmetrical current division or distribution between the three circuit connection units 5a, so that the total capacitance is made up of equal partial capacitances. That has the advantage, that the power capacitor 1, which is not shown, can respectively be operated according to the desired capacitance. Each circuit connection unit 5a preferably comprises busbars 9, by which the outer connection elements 8 are electrically and mechanically contactable with the capacitor unit 2 which is not shown.

A schematic circuit diagram of the power capacitor is illustrated in FIG. 7. The capacitor unit 2 is preferably constructed or made up of two parallel circuit-connected capacitor elements 3 and 4, for example with a capacitance of respectively 1000 μF each. Through the parallel circuit connection of the first capacitor element 3 and the second capacitor element 4, there arises a reduced capacitor series resistance relative to a series circuit connection. In order to achieve a minimum self inductance of the power capacitor, the inner circuit connection of the capacitor elements 3 and 4 is carried out by means of the busbars 9.

A schematic circuit diagram of the further embodiment of the power capacitor according to FIG. 6a is illustrated in FIG. 7a. The power capacitor can now be seen in such a manner as if it involves three individual power capacitors. The capacitor unit is circuit-connected with the three circuit connection units 5a and the busbars 9.

### REFERENCE CHARACTER LIST

1 power capacitor
2 capacitor unit
3 first capacitor element
4 second capacitor element
5 circuit connection unit
5a individual circuit connection unit
6 first circuit connection element
7 second circuit connection element
8 outer connection element
9 busbar
10 second connection element
11 connection lug or tab
12 housing
13 housing connections
14 first plastic shell
15 second plastic shell
16 insulation
17 plastic insert
18 spring pad

1. Power capacitor (1) for the installation in a motor vehicle comprising a capacitor unit (2) with at least one first and at least one second capacitor element (3, 4), whereby each capacitor element (3, 4) comprises at least two rolled-up plastic films provided with metal layers, and provided with metal-free edge strips on mutually opposite lying longitudinal sides, a circuit connection unit (5) and a housing (12), characterized in that the capacitor elements (3, 4) are circuit-connected in parallel by means of the circuit connection unit (5).

2. Power capacitor (1) according to claim 1, characterized in that the circuit connection unit (5) comprises a first and a second circuit connection element (6, 7), whereby the circuit connection elements (6, 7) comprise different potentials.

3-15. (canceled)

16. Power capacitor (1) according to claim 2, characterized in that each circuit connection element (6, 7) comprises at least one outer connection element (8).

17. Power capacitor (1) according to claim 16, characterized in that the outer connection elements (8) are arranged in such a manner that they adjoin one another with a small spacing distance and are electrically isolated relative to one another by an insulation (16).

18. Power capacitor (1) according to claim 16, characterized in that each circuit connection element (6, 7) comprises a busbar (9), via which the outer connection elements (8) are electrically and mechanically contactable with the capacitor unit (2).

19. Power capacitor (1) according to claim 18, characterized in that the busbars (9) are arranged over one another and are electrically isolated relative to one another.

20. Power capacitor (1) according to claim 18, characterized in that each busbar (9) comprises at least one second connection element (10) for the electrical and mechanical connection of the busbars (9) to the capacitor unit (2).

21. Power capacitor (1) according to claim 20, characterized in that the second connection elements (10) are deformable connection elements (11) with thermal tolerance and length compensation that are stamped out of the busbars (9).

22. Power capacitor (1) according to claim 20, characterized in that the second connection elements (11) connect the capacitor elements (3, 4), whereby the electrical connection is larger than the expansion coefficient of the capacitor elements (3, 4).

23. Power capacitor (1) according to claim 1, characterized in that the housing (12) is produced of aluminum and comprises mechanical housing connections (13) for the mechanical connection of the power capacitor (1) to a power electronics unit.

24. Power capacitor (1) according to claim 1, characterized in that the housing (12) and the capacitor unit (2) are electrically isolated relative to one another by means of a first plastic shell (14) of which the geometric dimensions essentially correspond to the dimensions of the capacitor unit (2).

25. Power capacitor (1) according to claim 24, characterized in that at least one mechanical energy storage element is arranged between the first plastic shell (14) and capacitor unit (2).

26. Power capacitor (1) according to claim 25, characterized in that the mechanical energy storage element is embodied as a spring pad.

27. Power capacitor (1) according to claim 16, characterized in that the power capacitor (1) comprises a second plastic shell (15) which at least partially encloses the circuit connection unit (5) at least on one side as well as the outer connection elements (8).

28. Power capacitor (1) according to claim 27, characterized in that the housing (12) and the capacitor unit (2) are electrically isolated relative to one another by means of a first plastic shell (14) of which the geometric dimensions essentially correspond to the dimensions of the capacitor unit (2).

29. Power capacitor (1) according to claim 28, characterized in that the plastic shells (14, 15) are electrical discharge puncture proof and are produced of polycarbonate.
